(19) United States
(12) Patent Application Publication
(10) Pub. No.: US 2012/0019695 A1
(43) Pub. Date: Jan. 26, 2012

(54) IMAGE SENSOR HAVING DARK SIDEWALLS BETWEEN COLOR FILTERS TO REDUCE OPTICAL CROSSTALK

(75) Inventors: Yin Qian, Milpitas, CA (US); Hsin-Chih Tai, San Jose, CA (US); Duli Mao, Sunnyvale, CA (US); Vincent Venezia, Los Gatos, CA (US); Howard E. Rhodes, San Martin, CA (US)

(73) Assignee: OMNIVISION TECHNOLOGIES, INC., Santa Clara, CA (US)

(21) Appl. No.: 12/843,578

(22) Filed: Jul. 26, 2010

(51) Int. Cl. H04N 5/335

(52) U.S. Cl. 348/273; 348/E05.091

(57) ABSTRACT

An apparatus and technique for fabricating an image sensor including the dark sidewall films disposed between adjacent color filters. The image sensor further includes an array of photosensitive elements disposed in a substrate layer, a color filter array (“CFA”) including CFA elements having at least two different colors disposed on a light incident side of the substrate layer, and an array of microlenses disposed over the CFA. Each microlens is aligned to direct light incident on the light incident side of the image sensor through a corresponding CFA element to a corresponding photosensitive element. The dark sidewall films are disposed on sides of the CFA elements and separate adjacent ones of the CFA elements having different colors.

### TECHNICAL FIELD

This disclosure relates generally to image sensors, and in particular, to filters for image sensors.

### BACKGROUND INFORMATION

Image sensors have become ubiquitous. They are widely used in digital still cameras, cellular phones, security cameras, medical devices, automobiles, and other applications. The technology used to manufacture image sensors, and in particular complementary metal-oxide semiconductor (“CMOS”) image sensors (“CIS”), has continued to advance at great pace. For example, the demands of higher resolution and lower power consumption have encouraged the further miniaturization and integration of the image sensor. Thus, the number of pixels in the pixel array of the image sensor has increased, while the size of each pixel cell has decreased.

A single pixel within a typical image sensor operates as follows. Light is incident on a micro-lens. The micro-lens focuses the light onto a photosensitive element through a filter. The photosensitive element converts the filtered light into an electrical signal proportional to the intensity of the incident light and the exposure duration. The electrical signal may be coupled to amplification and readout circuitry. An entire image is generated by capturing and reading out image data from an array pixels.

Conventional image sensors suffer from a variety of limitations. In image sensors that use front side illumination (“FSI”), layers of metal, polysilicon, diffusions, etc., are disposed between the micro-lenses and the photosensitive elements. During fabrication of image sensors that use FSI technology, a channel is therefore created for light to travel from the micro-lens to the photosensitive element in an effort to avoid the metal, polysilicon, diffusions, etc. These channels limit the quality of the image that can be captured using FSI technology.

One solution is to use back side illumination (“BSI”). In image sensors that use BSI, the layers of metal, polysilicon, diffusions, etc., are on the frontside of the substrate into which the photosensitive elements are integrated, while the light is incident from the backside of the substrate. Thus, there is no need to create limiting paths to the photosensitive elements to avoid the metal, polysilicon, diffusions, etc. Rather, light incident on the backside micro-lenses has direct, unconstrained paths from the micro-lenses through the filter layer to the photosensitive elements.

However, BSI image sensors suffer from limitations as well. For example, as the pixel size of BSI image sensors becomes smaller, it may be difficult for the micro-lens to focus incident light onto the photosensitive element. As a result, there can be crosstalk among the pixels. Crosstalk creates undesirable noise in the image sensor. In addition, there is no metal stack, which can help block light intended for a given pixel from entering an adjacent pixel. Moreover, as the pixel size or the micro-lens diameters approach or become smaller than the wavelength of visible light, focusing the incident light becomes even more difficult because of “the diffraction limit” of light.

One technique for reducing crosstalk is to increase the thickness of the color filters. This technique is believed to reduce the occurrence of optical crosstalk. However, this solution also reduces the quantum efficiency (“QE”) of the pixel cell. Another technique includes etching a carbon layer 110 (see FIG. 1) from every second column of a pixel array. Sidewalls 121 and 122 are formed on etched carbon layer 110. After sidewalls 121 and 122 are formed, etched carbon layer 110 is removed prior to depositing the color filter array between sidewalls 121 and 122. Disadvantages to this method include the number of additional fabrication steps and masks needed to fabricate and etched carbon layer 110 and sidewalls 121 and 122, before the color filter array can be deposited. The sidewalls produced by this method are wide, with the widest part of sidewall width, W, as seen in FIG. 1, located at the surface of passivation layer 101. As the size of pixel cells and color filters decrease, the width of sidewalls 121 and 122 becomes a greater issue and interfere with the path of incident light and quantum efficiency. Also, after etched carbon layer 110 is removed, sidewalls 121 and 122 are not supported by any structure until the color filter array is deposited, and may be easily damaged, so thinner sidewalls may not be a practical solution.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 (PRIOR ART) is a cross sectional view of a portion of an image sensor with sidewalls surrounding individual color filters.

FIG. 2 is a block diagram illustrating an imaging system, in accordance with an embodiment of the invention.

FIG. 3 is a circuit diagram illustrating pixel circuitry of two 4T pixels within an imaging system, in accordance with an embodiment of the invention.

FIG. 4 is a cross sectional view of a portion of a BSI image sensor, in accordance with an embodiment of the invention.

FIG. 5A is a cross sectional view of a partially fabricated BSI imaging sensor fabricated up to the formation of the green color filter array, in accordance with an embodiment of the invention.

FIG. 5B is a cross sectional view of a partially fabricated BSI imaging sensor illustrating conformal coating over the green color filter array, in accordance with an embodiment of the invention.

FIG. 5C is a cross sectional view of a partially fabricated BSI imaging sensor illustrating an anisotropic spacer etch, in accordance with an embodiment of the invention.

FIG. 5D is a cross sectional view of a partially fabricated BSI imaging sensor illustrating the formation of a remainder of the color filter array, in accordance with an embodiment of the invention.

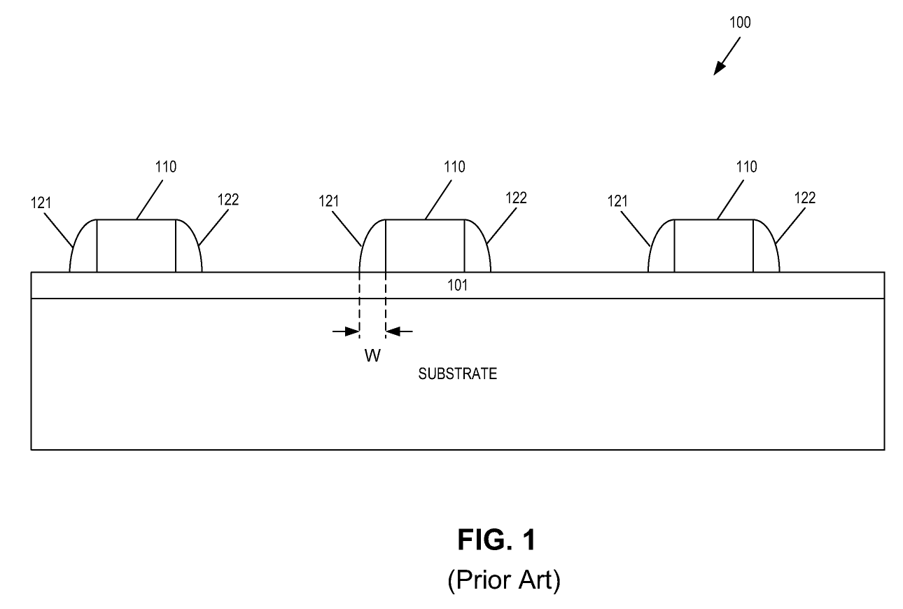

### DETAILED DESCRIPTION

Embodiments of an apparatus and system for an image sensor having reduced crosstalk is described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

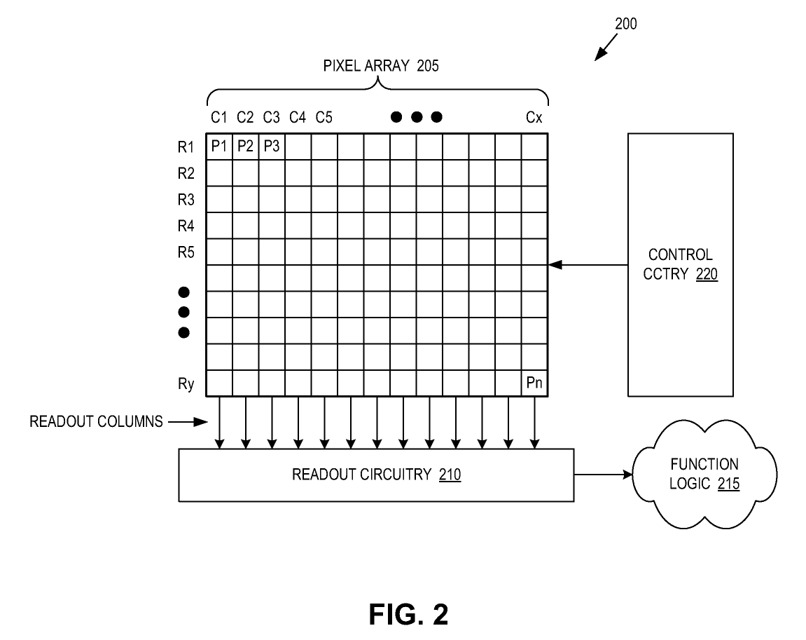

FIG. 2 is a block diagram illustrating an imaging system 200, in accordance with an embodiment of the invention. The illustrated embodiment of imaging system 200 includes a pixel array 205, readout circuitry 210, function logic 215, and control circuitry 220.

Pixel array 205 is a two-dimensional (“2D”) array of an image sensor or pixels (e.g., pixels P1, P2 . . . , Pn). In one embodiment, each pixel is a complementary metal-oxide-semiconductor (“CMOS”) imaging pixel. As illustrated, each pixel is arranged into a row (e.g., rows R1 to Ry) and a column (e.g., column C1 to Cx) to acquire image data of a person, place, or object, which can then be used to render a 2D image of the person, place, or object. In one embodiment, pixel array 205 is a backside illuminated (“BSI”) image sensor. In one embodiment, pixel array 205 is a frontside illuminated (“FSI”) image sensor. In one embodiment, pixel array 205 includes a color filter pattern disposed over the backside of the array, such as a Bayer pattern, a mosaic sequential pattern, or otherwise. The Bayer filter pattern is ordered with successive rows that alternate red and green filters, then green and blue filters—the Bayer filter pattern has twice as many green filters as red or blue filters.

After each pixel has acquired its image data or image charge, the image data is readout by readout circuitry 210 and transferred to function logic 215. Readout circuitry 210 may include amplification circuitry, analog-to-digital (“ADC”) conversion circuitry, or otherwise. Function logic 215 may simply store the image data or even manipulate the image data by applying post image effects (e.g., crop, rotate, remove red eye, adjust brightness, adjust contrast, or otherwise). In one embodiment, readout circuitry 210 may readout a row of image data at a time along readout column lines (illustrated) or may readout the image data using a variety of other techniques (not illustrated), such as a serial readout or a full parallel readout of all pixels simultaneously.

Control circuitry 220 is coupled to pixel array 205 to control operational characteristic of pixel array 205. For example, control circuitry 220 may generate a shutter signal for controlling image acquisition. In one embodiment, the shutter signal is a global shutter signal for simultaneously enabling all pixels within pixel array 205 to simultaneously capture their respective image data during a single acquisition window. In an alternative embodiment, the shutter signal is a rolling shutter signal whereby each row, column, or group of pixels is sequentially enabled during consecutive acquisition windows.

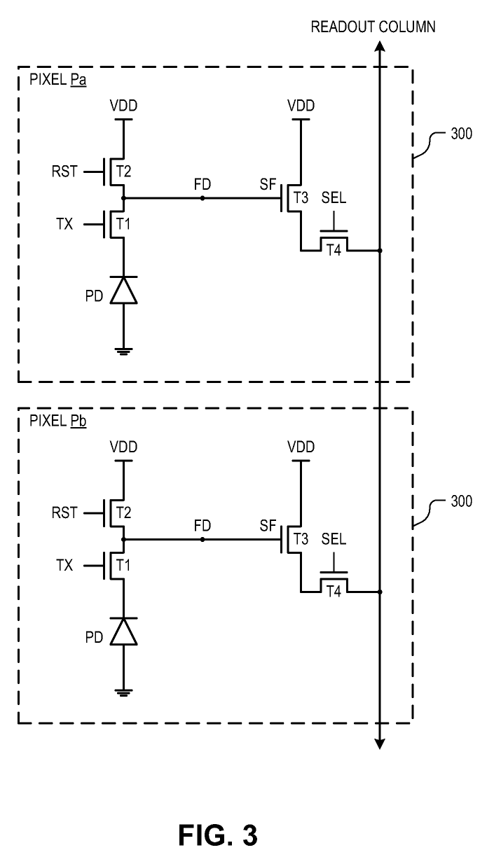

FIG. 3 is a circuit diagram illustrating pixel circuitry 300 of two four-transistor (“4T”) pixels within a pixel array, in accordance with an embodiment of the invention. Pixel circuitry 300 is one possible pixel circuitry architecture for implementing each pixel within pixel array 205 of FIG. 2. However, it should be appreciated that embodiments of the present invention are not limited to 4T pixel architectures; rather, one of ordinary skill in the art having the benefit of the instant disclosure will understand that the present teachings are also applicable to 3T designs, 5T designs, and various other pixel architectures. In FIG. 3, pixels Pa and Pb are arranged in two rows and one column. The illustrated embodiment of each pixel circuitry 300 includes a photodiode PD, a transfer transistor T1, a reset transistor T2, a source-follower (“SF”) transistor T3 and a select transistor T4. During operation, transfer transistor T1 receives a transfer signal TX, which transfers the charge accumulated in photodiode PD to a floating diffusion node FD. In one embodiment, floating diffusion node FD may be coupled to a storage capacitor for temporarily storing image charges. Reset transistor T2 is coupled between a power rail VDD and the floating diffusion node FD to reset (e.g., discharge or charge the FD to a preset voltage) under control of a reset signal RST. The floating diffusion node FD is coupled to control the gate of SF transistor T3. SF transistor T3 is coupled between the power rail VDD and select transistor T4. SF transistor T3 operates as a source-follower providing a high impedance output from the pixel. Finally, select transistor T4 selectively couples the output of pixel circuitry 300 to the readout column line under control of a select signal SEL. In one embodiment, the TX signal, the RST signal, and the SEL signal are generated by control circuitry 220.

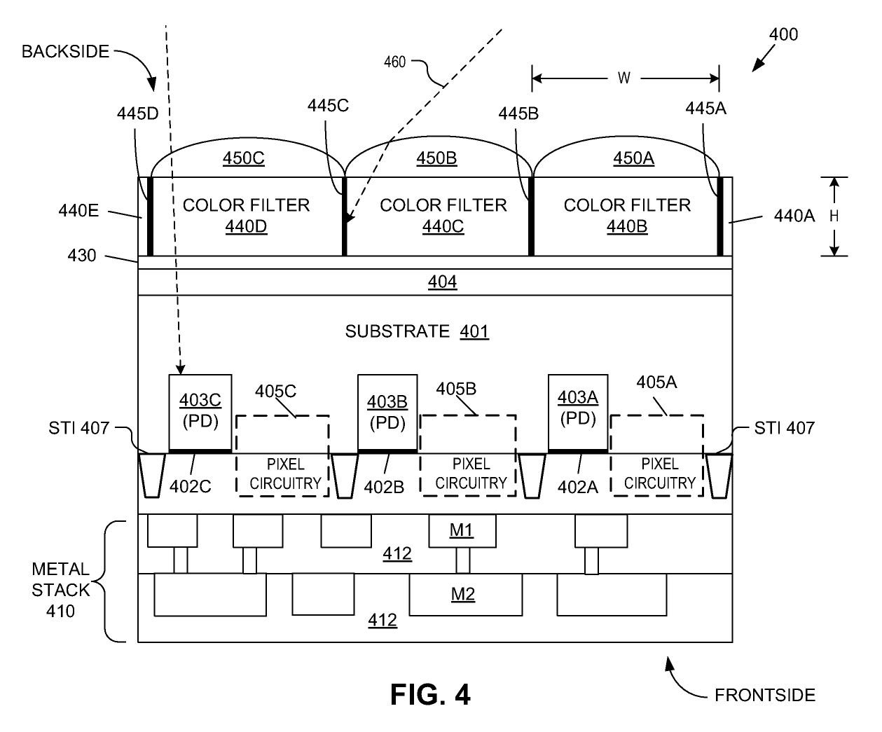

FIG. 4 is a cross sectional view of a portion of BSI image sensor 400, in accordance with an embodiment of the invention. FIG. 4 illustrates three adjacent pixels within BSI image sensor 400. The pixels of BSI image sensor 400 are one possible implementation of the pixels P1, P2, . . . , Pn within pixel array 205 in FIG. 2. The illustrated embodiment of BSI image sensor 400 includes a substrate 401, pinning regions 402A-C (collectively 402), photosensitive regions 403A-C (collectively 403), backside doped layer 404, pixel circuitry regions 405A-C (collectively 405), shallow trench isolations (“STI”) 407, metal stack 410, anti-reflective (“AR”) layer 430, color filters 440A-E (collectively 440), dark sidewall films 445A-D (collectively 445), and micro-lenses 450A-C (collectively 450).

The term substrate is used broadly herein and includes semiconductor bulk wafer layers, as well as, epitaxial layers formed on a bulk wafer layer. In some embodiments, substrate layer 401 is a semiconductor (e.g., silicon) epitaxial layer. Pixel circuitry 405A, 405B and 405C may each include transfer transistor T1, reset transistor T2, source follow transistor SF, and select transistor T4; however, so as not to clutter FIG. 4, these elements are represented with the dashed boxes. Metal stack 410 is disposed on the frontside of substrate 401 and includes metal layers M1 and M2 connected by vias and separated by inter-metal dielectric layers 412. Although the illustrate embodiment illustrates two metal layers, it should be appreciated that embodiments may include more or less metal layers separated by inter-metal dielectric layers. Pinning regions 402 are positioned at or near the front side surface of substrate 401 beneath photosensitive regions 403, but in other embodiments, the pinning regions can be positioned elsewhere or even omitted entirely. In one embodiment, substrate 401 is p type doped silicon, photosensitive regions 403 are n type doped regions that form photodiodes, and backside doped layer 404 is a p type doped layer having a higher dopant concentration than substrate 401. Backside doped layer 404 has an effect of enhancing charge collection into photosensitive regions 403 and reduces dark current generation at the backside surface of substrate 401.

Microlenses 450 are disposed on the backside of color filters 440. During operation, microlenses 450 direct backside incident light towards their respective photosensitive regions 403 through their respective color filters 440. The color filters filter the light to generate color images. A portion of the light that reaches photosensitive regions 403 is converter into photo-generated charge carriers which are collected and stored as electrical signals.

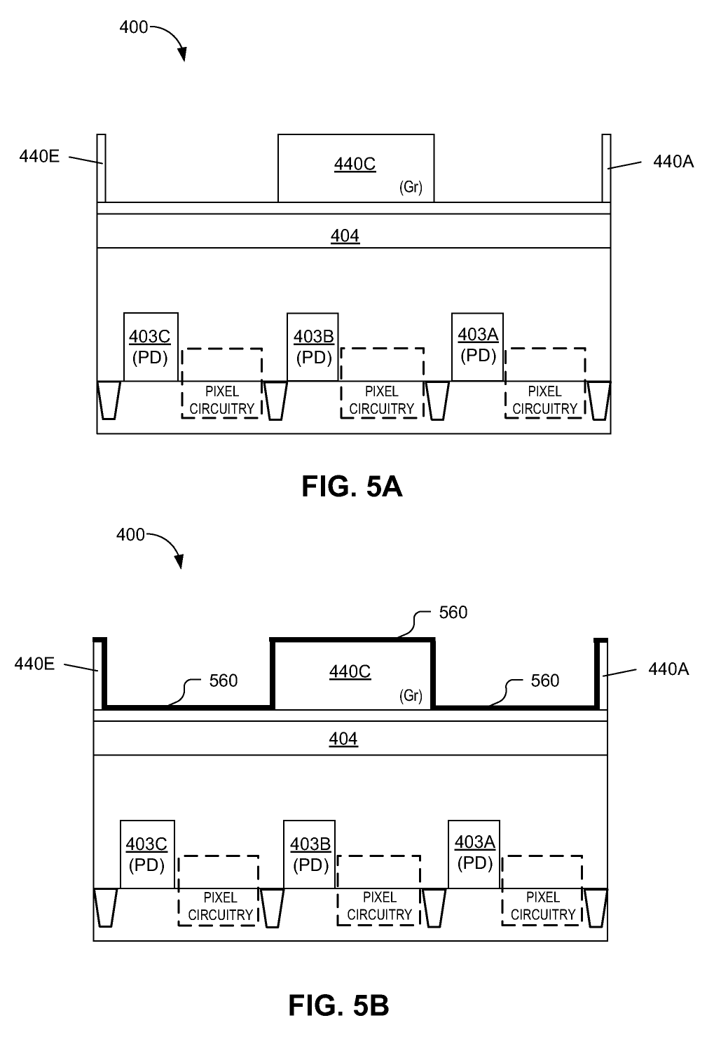

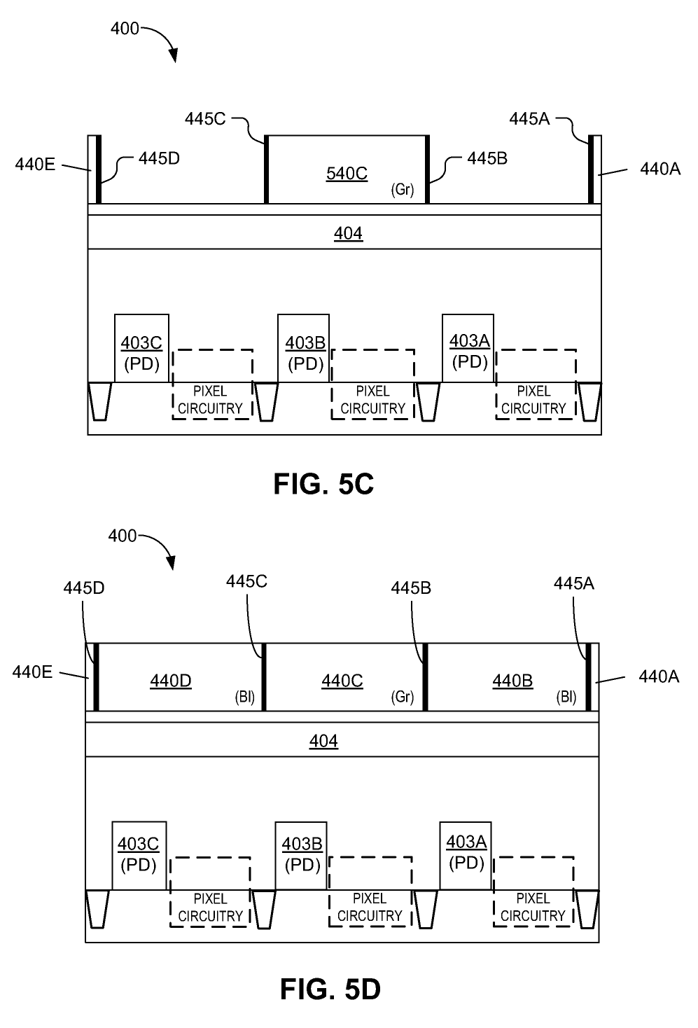

If the light is incident on microlenses 450 at a sufficiently large angle from normal, it can pass from one color filter 440 into an adjacent color filter 440 and be collected by the wrong photosensitive element 403. This form of cross-talk is referred to as color cross-talk and can detrimentally impact image quality and color quality of the image data. Accordingly, embodiments of the present invention include dark sidewall films 445 disposed between adjacent color filters 440. In one embodiment, dark sidewall films 445 are formed of a black material (or otherwise dark, opaque, or partially opaque material) or a material containing a black/dark dye, pigmentation, or substance such as carbon, graphite or CrO₃ and given a dark or black pigmentation to absorb off axis or oblique light (see light ray 460). Thus color crosstalk between pixels is reduced, since light entering a given color filter 440 is laterally blocked. In one embodiment, dark sidewall films 445 are substantially or nearly opaque. Due to the fabrication technique described below in connection with FIGS. 5A-5D, dark sidewall films 445 are relatively narrow and therefore have little impact on the overall aperture width W of each color filter 440. In one embodiment, the aperture width W of each color filter 440 is approximately 1.4 μm while the height H is approximately between 600 to 800 nm. In one embodiment, the thickness of dark sidewall films 445 is less than 10% of the aperture width W. In one embodiment, dark sidewall films 445 run the same height H as color filters 440 thereby isolating adjacent color filters 440 along their entire sides. In one embodiment, each dark sidewall film 445 is positioned below and aligned between the corners of adjacent microlenses 450.

FIGS. 5A-5D illustrate a technique for fabricating image sensor 400 including dark sidewall films 445, in accordance with an embodiment of the invention. FIG. 5A is a cross sectional view of a partially fabricated BSI image sensor 400, up to the formation of the green color filter array. Note, metal stack 410 is not illustrated in FIG. 5A (or the remaining FIGS. 5B-D) merely to simplify the drawings, though it is typically fabricated during the frontside processing following fabrication of the pixel circuitry 405 and prior to the backside processing of color filters 440. In a Bayer filter pattern, color filters are ordered with successive rows that alternate red and green color filters, then green and blue color filters. There are twice as many green color filters as red or blue color filters. The green color filters form a checkerboard pattern on the color filter array. In the illustrated embodiment, green color filters 440C are deposited and patterned on the backside of image sensor 400 using lithographic techniques.

After green color filters 440 are formed over the backside of image sensor 400, a dark conformal coating 560 is deposited over the green color filter array, as seen in FIG. 5B. Dark conformal coating 560 may be made of a variety of materials including: a black material (or otherwise dark, opaque, or partially opaque material) or a material containing a black/dark dye, pigmentation, or substance such as carbon, graphite or CrO₃ and has a substantially uniform thickness. In one embodiment, the thickness is less than 10% of the pixel size.

FIG. 5C illustrates an anisotropic etch performed on the backside of BSI image sensor 400. The etching process removes dark conformal coating 560 from the horizontal surfaces (e.g., topside of the green color filter array, and the exposed horizontal portions of the backside of BSI image sensor 400), so that the sides of each green color filter 440A, C, E remains coated with dark sidewall films 445. The remaining dark sidewall films 445 acts as an optical sidewall barrier between adjacent color filters to decrease crosstalk between adjacent pixels. Dark sidewall films 445 separate color filters 440, as illustrated in FIG. 5D.

Since dark sidewall films 445 are formed with a single conformal coating, they can be relatively thin compared to the width of the color filters 450 themselves, and will not significantly reduce the aperture size of each pixel. Accordingly, dark sidewall films 445 reduce color cross-talk while retaining the quantum efficiency (percentage of photons striking the backside of pixel array 205 that are collected as image charges within photosensitive regions 405) of BSI image sensor 400. The thickness of dark sidewall films 445 are substantially uniform from the top of the color filters to the bottom. The above technique of forming dark sidewall films 445 is a self aligned process, with little or no overlay control issues. Moreover, additional masks other than those used to form the color filters are not required.

In FIG. 5D, the remaining color filters 540B and 540C are formed, which depending upon the particular row are either both red color filter or both blue color filters in the case of a Bayer pattern filter array.

It should be noted that the above description assumes implementation of image sensors using red, green and blue photosensitive elements. Those skilled in the art having benefit of the instant disclosure will appreciate that the description is also applicable to other primary or complementary color filters. For example, magenta, yellow and cyan are a set of common alternative complementary colors that can be used to produce color images. If four colors are used in a color filter pattern, such as a cyan, yellow, green and magenta color filter pattern, two color filters can be patterened first to create a checkerboard pattern on the backside of the image sensor before the dark conformal coating is deposited. In addition, having a set of green photosensitive elements interleaved or interspersed with alternating red and blue photosensitive elements is also not necessary, though such configurations are common since the human vision system is more sensitive to colors in the green band than other colors in the visual spectrum.

The illustrated embodiments are BSI image sensors; however, it should be appreciated that embodiments of the invention can be applied to a frontside illuminated (FSI) image sensors as well. Dark sidewall films disposed between adjacent color filters may be used broadly to decrease cross-talk between pixels.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. An image sensor including an array of pixels disposed in a substrate layer, the image sensor comprising:
an array of photosensitive elements disposed in the substrate layer;
a color filter array (“CFA”) including CFA elements having at least two different colors disposed over a light incident side of the substrate layer;
an array of microlenses disposed over the CFA, wherein each microlens is aligned to direct light incident on the light incident side of the image sensor through a corresponding CFA element to a corresponding photosensitive element; and
dark sidewall films disposed on sides of the CFA elements and separating adjacent ones of the CFA elements having different colors.

2. The image sensor of claim 1, wherein the dark sidewall films are substantially opaque.

3. (canceled)

3. The image sensor of claim 1, wherein each of the dark sidewall films has a substantially uniform thickness.

4. The image sensor of claim 1, wherein the dark sidewall films contact adjacent CFA elements and define a boundary between the adjacent CFA elements.

5. The image sensor of claim 1, wherein the image sensor comprises a backside illuminated complementary metal-oxide semiconductor (“CMOS”) image sensor and the substrate layer comprises an epitaxial silicon layer.

6. The image sensor of claim 5, further comprising a metal stack including one or more metal layers separated by insulating dielectric layers disposed on a frontside of the array of pixels for routing signals over the frontside of the array of pixels.

7. The image sensor of claim 6, further comprising:
a backside doped layer having a higher dopant concentration than the substrate layer disposed between the substrate layer and the CFA; and
an anti-reflective layer disposed between the backside doped layer and the CFA.

8. The image sensor of claim 1, wherein the image sensor comprises a frontside illuminated complementary metal-oxide semiconductor (“CMOS”) image sensor and the substrate layer comprises an epitaxial silicon layer.

9. A method of fabricating an image sensor, the method comprising:
forming an array of photosensitive elements within a semiconductor layer;
forming an array of first color elements of a color filter array (“CFA”) over the array of photosensitive elements;
forming a dark coating over the array of first color elements;
removing first portions of the dark coating while retaining second portions of the dark coating on sides of the first color elements as dark sidewall films; and
forming an array of second color elements of the CFA interspersed with the array of first color elements, wherein the dark sidewall films separate the first color elements from the second color elements.

10. The method of claim 9, wherein removing the first portions of the dark coating comprises an anisotropic etch of the dark coating.

11. The method of claim 9, wherein the dark coating comprises a dark conformal coating having a substantially uniform thickness and the wherein the dark sidewall films have a substantially uniform thickness.

12. The method of claim 9, wherein the dark sidewall films are opaque or substantially opaque to visible light.

13. The method of claim 9, wherein the dark coating comprises a dark material pigmented with at least one of carbon, graphite or CrO₃.

14. The method of claim 9, wherein forming the array of first color elements of the CFA comprises:
depositing a first color layer of the CFA over the array of photosensitive elements; and
patterning the first color layer into the array of first color elements of the CFA.

15. The method of claim 9, further comprising:
forming an array of third color elements of the CFA interspersed with the arrays of the first and second color elements, wherein the dark sidewall films disposed on the sides of the first color elements separate the first, second, and third color elements from each other.

16. The method of claim 15, wherein the CFA comprises a Bayer pattern CFA and wherein the first color elements comprises green color elements.

17. The method of claim 9, wherein the image sensor comprises a complementary metal-oxide semiconductor (“CMOS”) image sensor.

18. The method of claim 17, wherein the CMOS image sensor comprises a backside illuminated image sensor, wherein CFA is formed on a backside of the CMOS image sensor, the method further comprising:
forming a metal stack including one or more metal layers separated by insulating dielectric layers disposed on a frontside of the CMOS image sensor for routing signals over the frontside of the array of photosensitive elements.

19. The image sensor of claim 1, wherein the dark sidewall films comprise a dark material pigmented with at least one of carbon, graphite or CrO₃.
